(19) United States
(12) Patent Application Publication
(10) Pub. No.: US 2008/0066777 A1
(43) Pub. Date: Mar. 20, 2008

(54) Bendable personal toothpick

(76) Inventors: Xiao Hai Wang, Princeton, NJ (US); Qing Raymond Wang, Princeton, NJ (US); Xiang Qian Liu, Princeton, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/900,802

(22) Filed: Sep. 13, 2007

Related U.S. Application Data
(60) Provisional application No. 60/844,334, filed on Sep. 13, 2006.

(51) Int. Cl. A61C 15/02

(52) U.S. Cl. 132/329

(57) ABSTRACT

The present invention relates to a personal toothpick having an adjustable inter-teeth inserting portion. The inter-teeth inserting portion is bendable to be formed at any angle. Thereafter, the inter-teeth inserting portion is forced laterally between any of the teeth, such as the back teeth, while the handle is at the front of the jaw, instead of being placed in redial position with reference to the curvature of the jaw. Accordingly, the toothpick can easily remove the foreign matters in small spaces between adjacent teeth, especially the back teeth.

### CROSS REFERENCE TO RELATED APPLICATION

This application claims the benefit of U.S. Provisional Patent Application No. 60/844,334, filed Sep. 13, 2007, the entirety of which is hereby incorporated by reference into this application.

### BACKGROUND OF THE INVENTION

1. Field of the Invention

This invention relates to a toothpick, specifically, to a toothpick with a bendable inter-teeth inserting portion which can be used to remove foreign mater from teeth and in particular between back teeth.

2. Description of Related Art

There are many toothpicks following designs of dental tools used by professional dentists. The inter-teeth inserting portion of such are typically formed of metal picks having different shapes. The toothpicks usually include a sharp point and fixed angle at the inter-teeth inserting portion, which can easily cut soft tissues around teeth. Their use is not satisfactory in the hand of unskilled users.

Although a traditional wooden toothpick has simple shape, a user needs to open their mouth widely to provide space for the toothpick to reach all the back teeth. Because the inter-teeth inserting portion has a fixed conical shape, the surrounding tissues of the teeth can be damaged and the spaces between teeth are widened by repeated use of the traditional wooden toothpick. Plastic versions of the wood toothpick designs are also known. However, they have also the same drawbacks as the wooded toothpick.

Although dental floss is highly recommended, it is not user friendly to everyone, because it requires a certain degree of oral and finger action and position. Although there are many devices that hold strands of dental floss taut so as to facilitate the “flossing” of the back teeth, it is difficult for the user to have to open his mouth wide enough to provide space for such devices.

Another design is the use of small conical-shaped brushes fixed onto a suitable handle. The dimensions of these brushes are such that they preclude their use in small, tight spaces. The disadvantage of brushes is that the brushes need to be replaced after a short period of usage and the brushes are difficult to maneuver.

It is desirable to provide a toothpick having a flexible inter-teeth inserting portion which provides more efficient and reliable action during removal of foreign matter from between the teeth particularly at the side of the jaw without damaging the tissue surrounding the teeth.

### SUMMARY OF THE INVENTION

The present invention relates to a personal toothpick having an adjustable inter-teeth inserting portion. The inter-teeth inserting portion is bendable to be formed at any angle. Thereafter, the inter-teeth inserting portion is forced laterally between any of the teeth, such as the back teeth, while the handle is at the front of the jaw, instead of being placed in radial position with reference to the curvature of the jaw. The diameter of the inter-teeth inserting portion is small, typically having a size less than the spacing between teeth, for example, in a range of less than about 1 mm.

Accordingly, the toothpick can easily remove the foreign matters in small spaces between adjacent teeth, especially the back teeth. The top end of the inter-teeth inserting portion is smooth and routed, which prevents from cutting gums and other soft tissue around the teeth. A rough surface around the top of the inter-teeth portion can be used to remove stains accumulated and plaque in spaces between adjacent teeth.

A cap for the toothpick can be used as a cover to keep the toothpick sanitary.

Besides removing foreign matter between the teeth, the toothpick of the present invention can also be used as an inter-dental stimulator for massaging the gums, when it is used daily as an alternative to flossing.

An aspect of the present invention is to provide a toothpick which is easy to carry and can be used repeatedly. It is desirable to employ the use of toothpicks to perform a cleaning function between the teeth when the user is at locations other than in the home and it can be used wherever needed. A further aspect of the invention is to provide a toothpick which is simple in construction and economical to manufacture.

Accordingly several advantages of the invention are to provide a toothpick with bendable inter-teeth inserting portion, and to provide means of more efficient and reliable action to remove foreign matter between the back teeth, to provide inter-teeth stimulator to massage user's gums, to provide conveniently carried, daily used, easily cleaned and economically manufactured personal toothpick.

The invention will be more fully described by reference to the following drawings.

### BRIEF DESCRIPTION OF THE DRAWINGS

FIG. 1 is a perspective front view of a bendable toothpick of the present invention.

FIGS. 2A-2D are perspective front views of the different shapes formed by the bendable toothpick.

FIG. 3A is a perspective front view of a bendable toothpick with a cap to cover an inter-teeth portion attached to the inter-teeth portion.

FIG. 3B is a perspective front view of the inter-teeth portion being received and stored in the cap.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

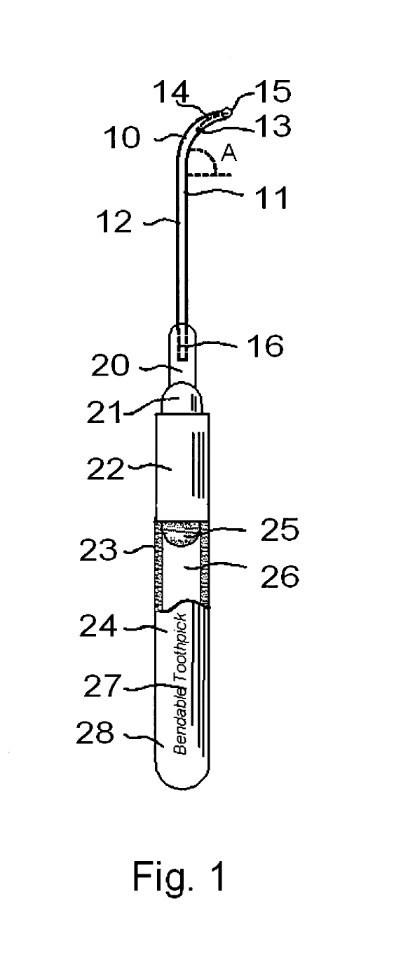

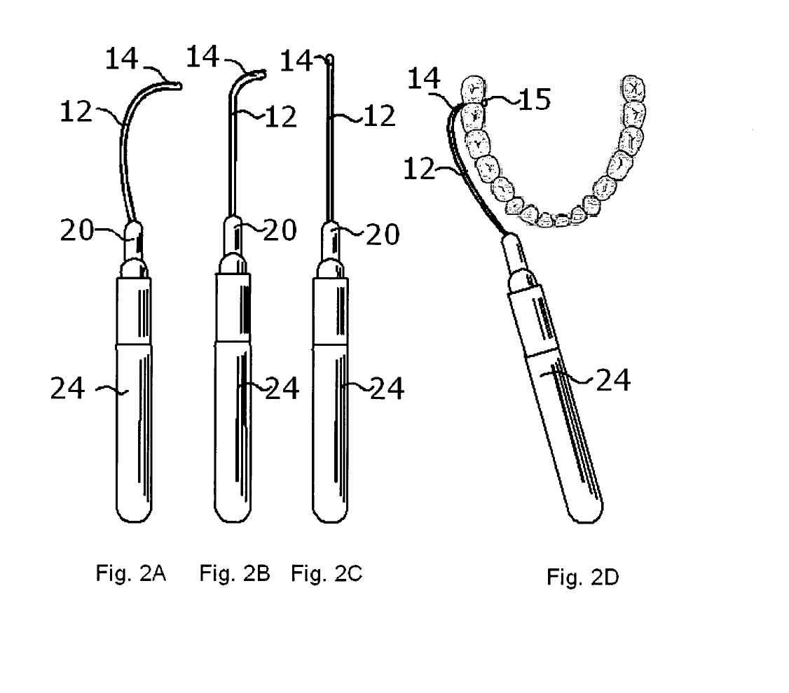

FIG. 1 is a schematic diagram of toothpick 10 in accordance with the teachings of the present invention. Toothpick 10 comprises inter-teeth insert portion 11. Inter-teeth insert portion 11 includes main body 12 and end portion 13. Main body 12 is bendable to a desirable angle depending on the comfort of the user. Main body 12 is bendable to any angle. For example, the angle A can be between 0 degrees and 90 degrees. Examples of bending of main body 12 are also shown in FIGS. 2A-2D. Main body 12 can bend to form a shape similar to the shape of curvature of the jaw for easy insertion between teeth, as shown in FIG. 2D. After main body 12 is bent to a desirable angle, main body 12 retains its shape.

The diameter of the inter-teeth inserting portion is small, typically having a size less than the spacing between teeth, for example, in a range of less than about 1 mm.

End portion 13 can include roughened surface 14. Roughened surface 14 can be used for removing stains accumulated and plaque in spaces between adjacent teeth. End portion 13 includes terminal end 15 which can be smooth and routed.

Terminal end 15 can have a rounded shape. Terminal end 15 can be inserted between teeth as shown in FIG. 2D without damaging soft tissue around the teeth. End 16 of main body 12 is coupled, inserted or integral with support 20 for holding and supporting inter-teeth insert portion 11. In one embodiment, main body 12 is coupled using connector 21 to support 20. Support 20 can be grasped by a user of toothpick 10.

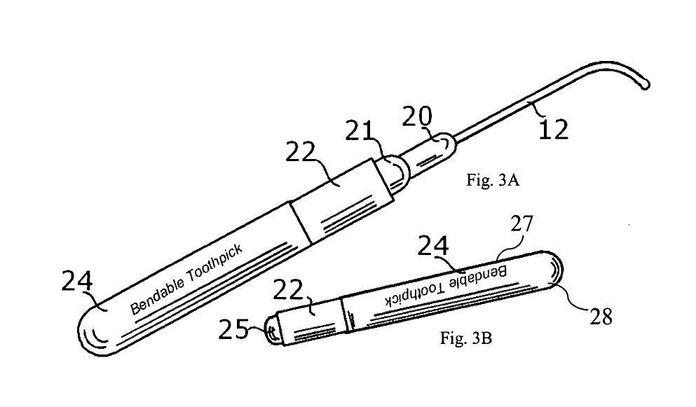

Connector 25 can connect cap 24 to support 20. Cap 24 can be removed by disconnecting portion 23 from connector 25, as shown in FIG. 1 and FIG. 3A. Cavity 26 is formed within cap 24. After use, cap 24 is removed from connector 25 and inter-teeth insert portion 11 can be inserted within cavity 26. Thereafter, cap 24 is attached using connector 21 to inter-teeth insert portion 11 for providing a storage and mobility of inter teeth insert portion 11, as shown in FIG. 3B. Indicia 27 can be imprinted on outside surface 28 of cap 24.

Suitable materials for inter-teeth insert portion 11 include metal, a synthetic material or bendable plastic which can bend a plurality of times without deformity. Suitable materials for support 20, connectors 21 and 25, cap 24 include plastic having a rigidity to provide support and housing of inter-teeth portion 11.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A bendable toothpick comprising:
an inter-teeth insert portion including a main body, a first end and a second end;
a portion of said main body adjacent said first end being bendable to an angle and bendable in a curvature shape; and
a support being coupled or integral with said second end of said main body for grasping;
wherein said main body retains said curvature shape and said first end of said main body is adapted to be insertable between teeth while said support is at a front of a jaw of said user.

2. The bendable toothpick of claim 1 wherein said angle is between about zero degrees and about 90 degrees.

3. The toothpick of claim 1 wherein said curvature shape is adapted to be similar to a jaw of user of said toothpick.

4. The toothpick of claim 1 wherein said first end has a roughened shape.

5. The toothpick of claim 1 wherein said first end has a terminal end having a rounded shape.

6. The toothpick of claim 4 wherein said terminal end is smooth.

7. The toothpick of claim 1 further comprising a cap removably connected to an opposite end of said support, wherein said cap includes a cavity for receiving said support and said inter-teeth insert portion.

8. The toothpick of claim 1 wherein said inter-teeth inserting portion has a diameter of less than about 1 mm.

9. The toothpick of claim 1 wherein said inter-teeth point is formed of metal.

10. The toothpick of claim 1 wherein said inter-teeth point is formed of bendable plastic.

11. The toothpick of claim 1 wherein said inter-teeth point is formed of a synthetic material which can bend a plurality of times.
